(19) United States
(12) Patent Application Publication
(10) Pub. No.: US 2010/0003534 A1
(43) Pub. Date: Jan. 7, 2010

(54) COMPOSITE PART CONSISTING OF A MULTI-LAYER FILM AND A SUBSTRATE BASED ON A POLYALKYL(METH)ACRYLATE

(75) Inventors: Kirsten Luetzeler, Muenster (DE); Klaus Huelsmann, Haltern am See (DE); Martin Wielpuetz, Senden (DE); Frank Lorenz, Olfen (DE); Roland Wursche, Duelmen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/438,364

(22) PCT Filed: Aug. 22, 2007
(86) PCT No.: PCT/EP07/58716

§ 371 Date: Mar. 26, 2009

(30) Foreign Application Priority Data
Aug. 26, 2006 (DE) 10 2006 040 113.1

(51) Int. Cl. B32B 27/36; B05D 1/36; B32B 37/02; B29C 43/00; B29C 45/16

(52) U.S. Cl. 428/480; 427/412.3; 156/60; 264/241

(57) ABSTRACT

A composite part is composed of
I. a multilayer film, which comprises the following layers:
   a) a layer composed of a polyamide moulding composition and
   b) following in the inwards direction, a layer composed of an adhesion promoter, which comprises from 5 to 100% by weight of a copolymer, which contains the following monomer units:
      from 70 to 99.9% by weight of monomer units which derive from vinyl compounds selected from acrylic acid derivatives, methacrylic acid derivatives, α-olefins and vinylaromatics, and
      from 0.1 to 30% by weight of monomer units which contain a functional group selected from a carboxylic anhydride group, an epoxide group and an oxazoline group, and
II. a substrate composed of a polyalkyl (meth)acrylate moulding composition.

The invention relates to composite parts composed of a multilayer film and of a substrate based on polyalkyl (meth)acrylate.

WO 2005/123384 describes composite parts which are composed of a multilayer film and of a part composed of an ABS moulding composition.

Injection-moulded or extruded mouldings composed of polyalkyl acrylate or polyalkyl methacrylate [e.g. polymethyl methacrylate (PMMA)] are widely used, because polyalkyl (meth)acrylates have transparency and other good optical and mechanical properties. However, polyalkyl (meth)acrylates lack chemicals resistance and have pronounced susceptibility to stress cracking, and mouldings composed thereof cannot therefore be used where there is some risk of exposure to solvents or to chemicals. EP 0 696 501 A2 states that this defect can be remedied through a firmly adherent coating of the polyalkyl (meth)acrylate articles with polyamide, although an adhesion promoter has to be used.

The choice of processing techniques is limited for producing the articles as described in EP 0 696 501 A2; this is particularly true for the production of decorated structural components. In addition, structural components produced as described in EP 0 696 501 A2 have unnecessarily thick layers of the costly polyamide and adhesion promoter materials, and this leads to elevated production costs.

An object underlying the invention is to eliminate these disadvantages and to achieve greater design freedom.

This object has been achieved via a composite part composed of
I. a multilayer film which comprises the following layers:
   a) a layer composed of a polyamide moulding composition and
   b) following in the inwards direction, a layer composed of an adhesion promoter, which comprises from 5 to 100% by weight of a copolymer, which contains the following monomer units:
      from 70 to 99.9% by weight of monomer units which derive from vinyl compounds selected from acrylic acid derivatives, methacrylic acid derivatives, α-olefins and vinylaromatics, and
      from 0.1 to 30% by weight of monomer units which contain a functional group selected from a carboxylic anhydride group, an epoxide group and an oxazoline group, and
II. a substrate composed of a polyalkyl (meth)acrylate moulding composition.

The invention also provides the use of the film according to I. for production of a composite part which comprises a substrate according to II.

No restriction applies to the polyamide of the layer according to I. a). The main materials that can be used here are aliphatic homo- and copolycondensates, such as PA46, PA66, PA88, PA610, PA612, PA810, PA1010, PA1012, PA1212, PA6, PA7, PA8, PA9, PA10, PA 11 and PA 12. (The terminology for the polyamides corresponds to an international standard where the first numeral(s) give(s) the carbon number of the starting diamine and the second numeral(s) give(s) the carbon number of the dicarboxylic acid. If only one numeral is given, this means that the starting material was an α,ω-aminocarboxylic acid or the lactam derived therefrom; for further information reference may be made to H. Domininghaus, Die Kunststoffe und ihre Eigenschaften [Plastics and their properties], pages 272 et seq., VDI-Verlag, 1976.)

If copolyamides are used these may contain, by way of example, adipic acid, sebacic acid, suberic acid, isophthalic acid, terephthalic acid, naphthalene-2,6-dicarboxylic acid, etc. as coacid and, respectively, bis(4-aminocyclohexyl)methane, bis(3-methyl-4-aminocyclohexyl)methane, trimethylhexamethylenediamine, hexamethylenediamine or the like as codiamine. There may also be lactams, such as caprolactam or laurolactam, or aminocarboxylic acids, such as ω-aminoundecanoic acid, incorporated as cocomponent.

The preparation of these polyamides is known (e.g. D. B. Jacobs, J. Zimmermann, Polymerization Processes, pp. 424-467, Interscience Publishers, New York, 1977; DE-B 21 52 194).

Other suitable polyamides are mixed aliphatic/aromatic polycondensates as described by way of example in U.S. Pat. Nos. 4,163,101, 4,603,166, 4,831,108, 5,112,685, 5,436,294 and 5,447,980, and also in EP-A-0 309 095. These are generally polycondensates whose monomers have been selected from aromatic dicarboxylic acids, such as terephthalic acid and isophthalic acid, from aliphatic dicarboxylic acids, such as adipic acid, from aliphatic diamines, such as hexamethylenediamine, nonamethylenediamine, dodecamethylenediamine and 2-methyl-1,5-pentanediamine, or else from lactams or ω-aminocarboxylic acids, such as caprolactam, laurolactam and ω-aminoundecanoic acid. The content of aromatic monomer units in the polycondensate is generally at least 0.1%, at least 5%, at least 10%, at least 15%, at least 20%, at least 25%, at least 30%, at least 35%, at least 40%, or at least 45% or about 50%, based on the entirety of the monomer units. These polycondensates are often termed “polyphthalamides” or “PPA”. Other suitable polyamides are poly(etheresteramides) or poly(etheramides); products of this type are described by way of example in DE-A 25 23 991, DE-A 27 12 987 and DE-A 30 06 961.

The polyamide moulding composition can either comprise one of these polyamides or two or more in the form of a mixture. As long as other thermoplastics do not impair bonding capability, up to 40% by weight of these can moreover be present, in particular impact-modifying rubbers, such as ethylene-propylene copolymers or ethylene-propylene-diene copolymers, polypentenylene, polyoctenylene, random or block copolymers composed of alkenyl aromatic compounds with aliphatic olefins or dienes (EP-A-0 261 748), or core-shell rubbers with a tough, resilient core composed of (meth)acrylate rubber, of butadiene rubber, or of styrene-butadiene rubber with glass transition temperatures T_{g}<−10° C., where the core may have been crosslinked and the shell can be composed of styrene and/or of methyl methacrylate and/or of other unsaturated monomers (DE-A 21 44 528, DE-A 37 28 685).

The polyamide moulding composition can receive additions of the auxiliaries and additives conventional for polyamides, examples being flame retardants, stabilizers, UV absorbers, plasticizers, processing aids, fillers, in particular for improving electrical conductivity, nanofillers, pigments, dyes, nucleating agents, or the like. The amount added of the agents mentioned is to be such as not to give any serious impairment of the desired properties. For most applications, it is desirable that the polyamide moulding composition has sufficient transparency at the layer thickness selected.

In one preferred embodiment, the monomer units of the polyamide which derive from diamine, dicarboxylic acid, or lactam (or aminocarboxylic acid) have an average of at least 8 carbon atoms and particularly preferably at least 9 carbon atoms.

For the purposes of the invention, particularly suitable polyamides are:
the polyamide composed of 1,12-dodecanedioic acid and 4,4′-diaminodicyclohexylmethane (PA PACM12), in particular starting from a 4,4′-diaminodicyclohexylmethane whose trans,trans-isomer content is from 35 to 65%;
the polyamide composed of sebacic acid or 1,12-dodecanedioic acid and 3,3′-dimethyl-4,4′-diaminodicyclohexylmethane;
PA612, PA1010, PA1012, PA11, PA12, PA1212, and mixtures thereof;
copolyamides that can be prepared from the following monomer combination:
   a) from 65 to 99 mol %, preferably from 75 to 98 mol %, particularly preferably from 80 to 97 mol % and with particular preference from 85 to 96 mol %, of an in essence equimolar mixture composed of an aliphatic unbranched diamine and of an aliphatic unbranched dicarboxylic acid, where the mixture, if appropriate, takes the form of salt and moreover each diamine and dicarboxylic acid is counted individually in the calculation of the constitution, with the restriction that the mixture composed of diamine and dicarboxylic acid contains an average of from 8 to 12 carbon atoms and preferably from 9 to 11 carbon atoms per monomer;
   b) from 1 to 35 mol %, preferably from 2 to 25 mol %, particularly preferably from 3 to 20 mol % and with particular preference from 4 to 15 mol % of an in essence equimolar mixture composed of a cycloaliphatic diamine and of a dicarboxylic acid.

The adhesion promoter comprises, as active agent, from 5 to 100% by weight, preferably from 10 to 80% by weight, particularly preferably from 15 to 60% by weight and with particular preference from 20 to 40% by weight of a copolymer which preferably contains the following monomer units:
1. From about 70 to about 99.9% by weight, preferably from 80 to 99.4% by weight and particularly preferably from 85 to 99% by weight of monomer units selected from units of the following formulae:

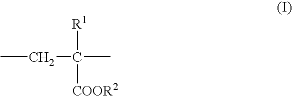

where R¹=H or CH₃ and R²=H, methyl, ethyl, propyl or butyl;

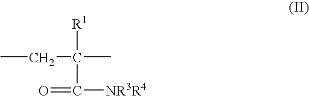

where R¹ is as above and R³ and R⁴, independently of one another, are H, methyl or ethyl;

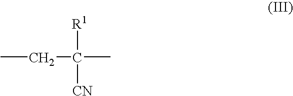

where R¹ is as above;

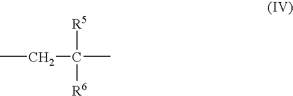

where R⁵=H or CH₃ and R⁶=H or C₆H₅;

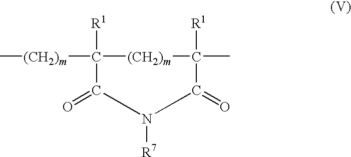

where R¹ is as above and R⁷=H, methyl, ethyl, propyl, butyl or phenyl and m=0 or 1;
2. from about 0.1 to about 30% by weight, preferably from 0.6 to 20% by weight and particularly preferably from 1 to 15% by weight of monomer units selected from units of the following formulae:

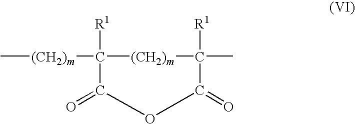

where R¹ and m are as above;

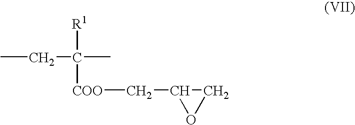

where R¹ is as above;

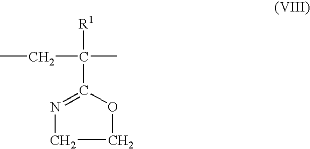

where R¹ is as above.

The limitation of chain length in the case of substituents R¹ to R⁵ and R⁷ is based on the fact that longer alkyl radicals lead to a lowered glass transition temperature and therefore to reduced heat resistance. This may be acceptable in a few cases.

The units of the formula (I) derive by way of example from acrylic acid, methacrylic acid, methyl acrylate, ethyl acrylate, n-butyl acrylate, methyl methacrylate, n-propyl methacrylate, or isobutyl methacrylate.

The units of the formula (II) derive by way of example from acrylamide, methacrylamide, N-methylacrylamide, N-methylmethacrylamide, or N,N-dimethylacrylamide.

The units of the formula (III) derive from acrylonitrile or methacrylonitrile.

The units of the formula (IV) derive from ethene, propene, styrene or α-methylstyrene; these can be replaced entirely or to some extent by other polymerizable aromatics, such as p-methylstyrene or indene, which have the same effect.

If m=0, the units of the formula (V) derive from unsubstituted or substituted maleimides, such as maleimide, N-methylmaleimide, N-ethylmaleimide, N-phenylmaleimide, or N-methylaconitimide. If m=1, they derive via reaction with ammonia or with a primary amine of two adjacent units of the formula (I) in a polymer, forming an imide.

If m=0, the units of the formula (VI) derive from unsubstituted or substituted maleic anhydrides, such as maleic anhydride or aconitic anhydride. These latter compounds can be replaced entirely or to some extent by other unsaturated anhydrides, e.g. itaconic anhydride, which have the same effect. If m=1, they derive via elimination of water from two adjacent units of the formula (I) in a polymer (R²=H), with ring closure.

The units of the formula (VII) derive from glycidyl acrylate or glycidyl methacrylate, and the units of the formula (VIII) derive from vinyloxazoline or isopropenyloxazoline.

Various embodiments of the copolymer are preferred, and contain the following units:
A. from 14 to 96% by weight, preferably from 20 to 85% by weight, and particularly preferably from 25 to 75% by weight, of units of the formula (I), where R² is not H;
   from 0 to 75% by weight, preferably from 1 to 60% by weight, and particularly preferably from 5 to 40% by weight, of units of the formula (V), where m=1;
   from 0 to 15% by weight, preferably from 0 to 10% by weight, and particularly preferably from 0.1 to 7% by weight, of units of the formula (I), where R²=H;
   from 0.1 to 30% by weight, preferably from 1 to 20% by weight, and particularly preferably from 2 to 15% by weight, of units of the formula (VI), where m=1.
   If units of the formula (V) are present, these copolymers are termed polyacrylimides or polymethacrylimides or sometimes also polyglutarimides. These are products which come from polyalkyl acrylates and, respectively, polyalkyl methacrylates, in which two adjacent carboxylate groups have been reacted to give a cyclic imide. The imide is preferably formed with ammonia or with primary amines, e.g. methylamine, in the presence of water, and the units of the formula (VI) and, where appropriate, units of the formula (I), where R²=H, are produced concomitantly via hydrolysis. The products are known, as also is their preparation (Hans R. Kricheldorf, Handbook of Polymer Synthesis, Part A, Verlag Marcel Dekker Inc. New York-Basle-Hongkong, pp. 223 et seq., H. G. Elias, Makromolekule [Macromolecules], Hüthig und Wepf Verlag Basle-Heidelberg-New York; U.S. Pat. No. 2,146,209 A; U.S. Pat. No. 4,246,374). If water only is used for the reaction, the product is units of the formula (VI) and also, if appropriate, acidic units (I) via hydrolysis, without formation of imide units (V).
B. from 10 to 60% by weight, preferably from 15 to 50% by weight and particularly preferably from 20 to 40% by weight of units of the formula (IV);
   from 39.9 to 80% by weight, preferably from 44.9 to 75% by weight and particularly preferably from 49.9 to 70% by weight of units of the formula (III);
   from 0.1 to 30% by weight, preferably from 0.6 to 20% by weight and particularly preferably from 1 to 15% by weight of units of the formula (VI), where m=0.
   Copolymers of this type are obtainable in a known manner via free-radical-initiated copolymerization of, for example, aliphatically unsaturated aromatics, unsaturated carboxylic anhydrides, and acrylonitrile or methacrylonitrile.
C. from 39.9 to 99.9% by weight, preferably from 49.9 to 99.4% by weight and particularly preferably from 59.9 to 99% by weight, of units of the formula (I);
   from 0 to 60% by weight, preferably from 0.1 to 50% by weight and particularly preferably from 2 to 40% by weight of units of the formula (IV);
   from 0.1 to 30% by weight, preferably from 0.6 to 20% by weight and particularly preferably from 1 to 15% by weight of units of the formula (VI), where m=0.
   Copolymers of this type are obtainable in a known manner via free-radical-initiated copolymerization of acrylic acid, methacrylic acid and/or esters thereof and, if appropriate, aliphatically unsaturated aromatics or olefins and unsaturated carboxylic anhydrides.
D. from 25 to 99.8% by weight, preferably from 40 to 98.4% by weight and particularly preferably from 50 to 97% by weight of units of the formula (I);
   from 0.1 to 45% by weight, preferably from 1 to 40% by weight and particularly preferably from 2 to 35% by weight of units of the formula (III);
   from 0.1 to 30% by weight, preferably from 0.6 to 20% by weight and particularly preferably from 1 to 15% by weight of units of the formula (VI), where m=0.
   Copolymers of this type are obtainable in a known manner via free-radical-initiated copolymerization of acrylic acid, methacrylic acid, and/or esters thereof, or acrylonitrile or methacrylonitrile and unsaturated carboxylic anhydrides.
E. ABS polymer which contains from 0.1 to 30% by weight, preferably from 0.6 to 20% by weight, and particularly preferably from 1 to 15% by weight, of units of the formula (VI), where m=0. These can have been polymerized into the chains or can have been grafted onto the chains.
F. from 0 to 99.9% by weight, preferably from 0.1 to 99.4% by weight, and particularly preferably from 2 to 99% by weight, of units selected from the formulae (I), where R² is not H, and (III),
   from 0 to 60% by weight, preferably from 0.1 to 50% by weight, and particularly preferably from 2 to 40% by weight, of units of the formula (IV),
   from 0.1 to 30% by weight, preferably from 0.6 to 20% by weight, and particularly preferably from 1 to 15% by weight, of units of the formula (VII).
G. from 0 to 99.9% by weight, preferably from 0.1 to 99.4% by weight, and particularly preferably from 2 to 99% by weight, of units selected from the formulae (I), where R² is not H, and (III),
   from 0 to 60% by weight, preferably from 0.1 to 50% by weight, and particularly preferably from 2 to 40% by weight, of units of the formula (IV),
   from 0.1 to 30% by weight, preferably from 0.6 to 20% by weight, and particularly preferably from 1 to 15% by weight, of units of the formula (VIII).

The copolymer can always contain other additional monomer units, such as those which derive from maleic diesters, from fumaric diesters, from itaconic esters from vinyl acetate, as long as the desired adhesion-promoting effect is not substantially impaired thereby.

In one embodiment, the adhesion promoter can be composed entirely of the copolymer; in a variant of this, the copolymer comprises an impact modifier, e.g. an acrylate rubber.

In a second embodiment, the adhesion promoter comprises from 5 to 99.9% by weight, preferably from 10 to 80% by weight, particularly preferably from 15 to 60% by weight, and with particular preference from 20 to 40% by weight, of the copolymer, and from 0.1 to 95% by weight, preferably from 20 to 90% by weight, particularly preferably from 40 to 85% by weight, and with particular preference from 60 to 80% by weight, of polyalkyl (meth)acrylate, polycarbonate, MBS (methyl methacrylate-butadiene-styrene copolymer, e.g. CYROLITE® from Röhm GmbH), SAN (styrene-acrylonitrile copolymer) and/or ABS.

In a third embodiment, the adhesion promoter comprises from 5 to 99.9% by weight, preferably from 10 to 80% by weight, particularly preferably from 15 to 60% by weight, and with particular preference from 20 to 40% by weight, of the copolymer, and from 0.1 to 95% by weight, preferably from 20 to 90% by weight, particularly preferably from 40 to 85% by weight, and with particular preference from 60 to 80% by weight, of a mixture composed of polyamide and of a polymer selected from polycarbonate, SAN, ABS and polyalkyl (meth)acrylate in a ratio of from 99.9:0.1 to 0.1:99.9, preferably from 70:30 to 10:90, by weight.

In further embodiments, the adhesion promoter can comprise, alongside the copolymer, other suitable polymers which at least do not impair adhesion to the polyamide layer and to the substrate.

The adhesion promoter can comprise the usual auxiliaries and additives, e.g. flame retardants, stabilizers, plasticizers, processing aids, dyes, pigments or the like. The amount fed of the agents mentioned is to be such as not to give any serious impairment of the desired properties.

The adhesion promoter according to the claims achieves firm adhesion between the polyamide layer and the substrate.

The film can, as a function of application, comprise further layers alongside the layers which are present according to the invention, being composed of a polyamide moulding composition, and alongside the adhesion promoter according to the claims, one example being a backing layer which is on the substrate side and which is composed of a polyalkyl (meth)acrylate moulding composition preferably substantially identical in terms of polymer constitution with the substrate, or an MBS moulding composition, ABS moulding composition or polycarbonate moulding composition, and another example being a colour layer, a further polyamide layer, for example in the form of supportive layer, and/or a protective layer or a clearcoat.

The colour layer can be a lacquer layer; however, it is preferably composed, in accordance with the prior art, of a coloured thermoplastic layer. The thermoplastic layer can be identical with the layer according to I. a). In a further embodiment, the colour layer can follow the layer according to I. a), towards the outside or towards the inside. If appropriate, and if required for reasons of applications technology, the film is covered by a clearcoat towards the outside, in order, for example, to ensure that the colouring has a desired depth effect. Examples of colorants that can be used are organic dyes, inorganic or organic pigments, or metal flakes.

The clearcoat can, for example, in accordance with the prior art, be composed of polyamide, of an acrylate polymer, of a fluoropolymer, or of a mixture thereof. It is intended to provide the visual surface properties demanded and to protect the layers lying thereunder. It can also, for example, be a clear lacquer based on polyurethane. A protective layer in the form of a lacquer can also have been modified in accordance with the prior art in order to increase scratch resistance. A protective layer can also be generated on the component by way of vacuum-deposition processes.

If the clearcoat is a polyamide, it is particularly possible to use the polyamides mentioned above as particularly suitable for the layer according to I. a).

The clearcoat can, if appropriate, have transparent colouring, but is preferably uncoloured.

A supportive layer is a layer whose thickness gives greater strength to the film.

A peelable protective film which provides protection during transport or assembly and which is peeled off after production of the composite part can also be laminated to the finished multilayer film.

In one preferred embodiment, the layer according to I. a), the colour layer and/or the supportive layer comprises a moulding composition which comprises a polyetheramide or a polyetheresteramide, and preferably a polyetheramide or polyetheresteramide based on a linear aliphatic diamine having from 6 to 18 and preferably from 6 to 12 carbon atoms, on a linear aliphatic or an aromatic dicarboxylic acid having from 6 to 18 and preferably from 6 to 12 carbon atoms and on a polyether having an average of more than 2.3 carbon atoms per oxygen atom and having a number-average molecular weight of from 200 to 2000. The moulding composition of this layer can comprise other blend components, e.g. polyacrylates or polyglutarimides having carboxy or carboxylic anhydride or epoxy groups, a rubber containing functional groups, and/or a polyamide. Moulding compositions of this type are prior art; they are described by way of example in EP 1 329 481 A2 and DE-A 103 33 005, expressly incorporated herein by way of reference. In order to provide good layer-adhesion with respect to any following polyamide layer present towards the outside or else towards the inside, it is advantageous that the polyamide fraction of the polyamide elastomer here is composed of monomers identical with those used in one of the components of the polyamide layer. However, this is not essential to achieve good adhesion. As an alternative to the polyamide elastomer, the layer I. a), the colour layer and/or the supportive layer can also comprise a usual impact-modifying rubber, alongside a polyamide. An advantage of these embodiments is that in many cases there is no need for thermoforming of the film as a separate step prior to reverse coating by an injection-moulding method, since that process also simultaneously subjects the film to a forming process.

Examples of useful layer arrangements of the film used according to the invention, in each case from the outside to the inside (towards the substrate) are:
a) layer according to I. a/layer according to I. b)
b) layer according to I. a/layer according to I. b)/layer composed of polyalkyl (meth)acrylate
c) clearcoat/layer according to I. a) as colour layer/layer according to I. b)
d) clearcoat/colour layer/layer according to I. a)/layer according to I. b)
e) clearcoat/supportive layer/layer according to I. a)/layer according to I. b)
f) clearcoat/colour layer/supportive layer/layer according to I. a)/layer according to I. b)
g) clearcoat/colour layer/supportive layer/layer according to I. a)/layer according to I. b)/layer composed of polyalkyl (meth)acrylate

In one preferred embodiment, the thickness of the multilayer film is from 0.02 to 1.2 mm, particularly preferably from 0.05 to 1 mm, very particularly preferably from 0.1 to 0.8 mm, and with particular preference from 0.2 to 0.6 mm. In one preferred embodiment here, the thickness of the adhesion-promoter layer is from 0.01 to 0.5 mm, particularly preferably from 0.02 to 0.4 mm, very particularly preferably from 0.04 to 0.3 mm, and with particular preference from 0.05 to 0.2 mm. The film is produced by means of known methods, for example via extrusion, or in the case of multilayer systems via coextrusion or lamination. It can then be subjected to a forming process, if appropriate.

The coherent bonding of the film to the substrate can be produced, for example, via adhesive bonding, pressing, lamination, or reverse coating by an injection-moulding, foaming or compression-moulding method. Prior to formation of the bond between film and substrate, the film can also be subjected to mechanical working or to a forming process, for example via thermoforming, deep drawing or other processes. The surface can, for example, be textured via embossing. Texturing of the surface is also a possible upstream step in the context of extrusion of a film, for example via specifically designed rolls. The resultant composite part can then be subjected to a forming process.

The substrate is composed particularly of polyalkyl (meth)acrylates having 1 to 6 carbon atoms in the carbon chain of the alkyl radical, and methyl is a preferred alkyl. The Melt Flow Rate of the polyalkyl methacrylates is typically in the range from 0.5 to 30 g/10 min and preferably in the range from 0.8 to 15 g/10 min, when measured to ISO 1133 at 230° C. under a load of 3.8 kg. Polymethyl methacrylate and polybutyl methacrylate may be mentioned by way of example. However, copolymers of the polyalkyl (meth)acrylates can also be used. Up to 50% by weight, preferably up to 30% by weight and more preferably up to 20% by weight of the alkyl (meth)acrylate can be replaced by other monomers such as, for example, methacrylic acid, styrene, acrylonitrile, acrylamide or the like. The moulding composition may be impact toughened, for example by adding a core-shell rubber typical for such moulding compositions. In addition, the moulding composition may contain up to less than 50% by weight, preferably up to not more than 40% by weight, more preferably up to not more than 30% by weight and even more preferably up to not more than 20% by weight of other thermoplastics such as, for example, SAN (styrene-acrylonitrile copolymer), ABS and/or polycarbonate. The polyalkyl (meth)acrylate may further contain stabilizers, processing aids, fillers, reinforcing agents, dyes, pigments and other customary additives or admixtures in the customary amounts. Suitable moulding compositions are prior art; see for example EP 0 716 122 A2, EP 0 776 931 A1, WO 99/42271 and U.S. Pat. No. 5,232,986.

In one preferred embodiment, the claimed film is used as outer layer of an optical component. Examples of these are diffuser sheets, headlight lenses, tail-light lenses, other lenses, prisms, spectacle lenses, displays, decorative components for displays, panels of any type, and mobile-telephone casings.

In another preferred embodiment, the film according to the claims is used as outer layer of a film composite for the design or decoration of surfaces on and in automobiles and commercial vehicles, where the film has adhesive bonding to the substrate. The correspondingly designed component can have been shaped in the form of a sheet, for example a bodywork part, such as a roof module, wheel surround, engine cover or door. Other embodiments that can be used are those in which elongate components having some degree of curvature are produced, for example cladding, such as the cladding of what are known as A columns on an automobile, and decorative and cover strips of any type, for example radio covers. Protective cladding for door sills is another example. Alongside applications on the exterior of automobiles, constituents of the interior can also be advantageously decorated via the inventive films, in particular decorative elements such as strips and panels, since impact resistance and resistance to chemicals, such as cleaning compositions, is also a requirement in the interior.

The film can moreover be used, for example, as protective film with respect to soiling, UV radiation, effects of weathering, chemicals or abrasion, as barrier film on vehicles, in households, on floors, tunnels, on tents and on buildings, or as a carrier of decorative effects, for example for topcoats of sports equipment, of boats, of aircraft, or in the household, or on buildings. Other examples here are medical items, sanitary items and hygiene articles, e.g. shavers, electric toothbrushes, and medical equipment and, respectively, components.

The following examples are intended to illustrate the invention. The following materials were used in the examples:

| | |
|---|---|
| PA PACM12: | TROGAMID ® CX7323 (Degussa GmbH) |
| PA12: | A type whose relative solution |
| | viscosity ηᵣₑₗ is 2.1, determined |
| | to ISO 307 |
| PA1012: | A type whose relative solution |
| | viscosity ηᵣₑₗ is 2.1 |
| PA1010: | A type whose relative solution |
| | viscosity ηᵣₑₗ is 2.0 |
| Adhesion promoter (AP): | A copolymer whose constitution is |

a) 57% by weight of monomer units of the formula

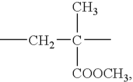

b) 30% by weight of monomer units of the formula

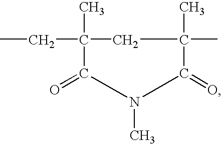

c) 3% by weight of monomer units of the formula

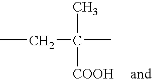

d) 10% by weight of monomer units of the formula

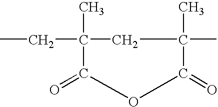

The copolymer, a polymethacrylimide, can be prepared via reaction of a melt of polymethyl methacrylate (PMMA) with an aqueous methylamine solution, for example in an extruder.

| | |
|---|---|
| PMMA: | PLEXIGLAS ® 7N (Röhm GmbH) |

The multilayer films were produced on a Collin plant whose take-off speed was 2.0 m/min. The individual extruded layers were combined and run through a calender. The width of the films was 24 cm; the thickness of the polyamide layer was about 180 μm and the thickness of the adhesion-promoter layer was about 240 μm.

The reverse coating by an injection-moulding method was carried out on an Engel 650/200 machine using a mould temperature of 80° C. and a melt temperature of 260° C.

The film here was trimmed to 100 mm×150 mm format and placed in a mould (105 mm×150 mm×0.8-10 mm sheet). The thickness of the sheet thus coated was 3 mm, inclusive of film.

For comparative measurements, analogous sheets composed of PMMA, but without film, were produced correspondingly.

TABLE 1
Inventive Examples 1 to 4 and Comparative
Example A

| | Example | | | | |
|---|---|---|---|---|---|
| | 1 | 2 | 3 | 4 | A |
| Film | PA | PA12/HV | PA | PA 1010/ | — |
| | PACM12/HV | | 1012/HV | HV | |
| Substrate | PMMA | PMMA | PMMA | PMMA | PMMA |

When an attempt was made to separate the composites mechanically, firm adhesion at the boundaries between the layers was found in all the Inventive Examples. In all cases the result was not separation, but instead was cohesive failure of the layers of the film.

The transparency of the composite articles was not discernibly impaired by the thin film, even when using the partly crystalline polyamides PA12, PA1012 and PA1010.

After treatment with drops of toluene at 23° C., the surface of the PMMA in Comparative Example A was appreciably damaged by stress cracking. In Inventive Examples 1 to 4, by contrast, no stress cracking whatsoever was observed after application of the toluene to the film side.

Similar results were obtained when the films produced were deep drawn, placed in a three-dimensionally curved mould and then reverse coated by an injection-moulding method.

1. A method of producing a composite part, which comprises:
a) depositing a layer of an adhesion promoter, which comprises from 5 to 100% by weight of a copolymer, which contains the following monomer units:
from 70 to 99.9% by weight of monomer units which are derived from vinyl compounds selected from the group consisting of acrylic acid derivatives, methacrylic acid derivatives, α-olefins and vinylaromatics, and
from 0.1 to 30% by weight of monomer units which contain a functional group selected from the group consisting of a carboxylic anhydride group, an epoxide group and an oxazoline group, on a surface of a substrate composed of a polyalkyl (meth)acrylate moulding composition, and
b) depositing a layer composed of a polyamide moulding composition on the layer comprised of said adhesion promoter, thereby forming a multilayer film.

2. The method according to claim 1,
wherein the copolymer contains the following monomer units:
a) from 70 to 99.9% by weight of monomer units selected from the group consisting of units of the following formulae: 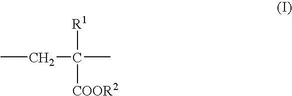
where R¹=H or CH₃ and R²=H, methyl, ethyl, propyl or butyl; 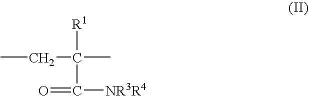
where R¹ is as above and R³ and R⁴, independently of one another, are each H, methyl or ethyl; 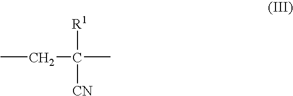
where R¹ is as above; 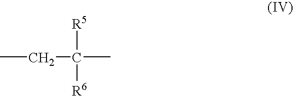
where R⁵=H or CH₃ and R⁶=H or C₆H₅; 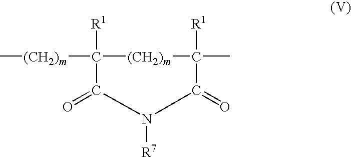
where R¹ is as above and R⁷=H, methyl, ethyl, propyl, butyl or phenyl and m=0 or 1;
b) from 0.1 to 30% by weight of monomer units selected from units of the following formulae: 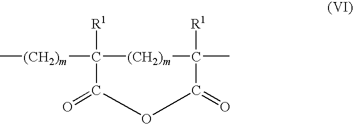
where R¹ and m are as above; 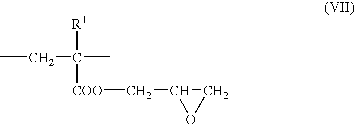
where R¹ is as above; 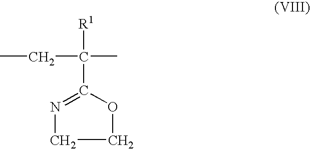
where R¹ is as above.

3. The method according to claim 1,
wherein the adhesion promoter comprises from 5 to 99.9% by weight of the copolymer and from 0.1 to 95% by weight of polyalkyl(meth)acrylate, polycarbonate, SAN, MBS and/or ABS.

4. The method according to claim 1,
wherein the adhesion promoter comprises from 5 to 99.9% by weight of the copolymer and from 0.1 to 95% by weight of a mixture comprised of polyamide and of a polymer selected from the group consisting of polyalkyl(meth)acrylate, polycarbonate, SAN, MBS and ABS in a ratio of from 99.9:0.1 to 0.1:99.9 by weight.

5. The method according to claim 1,
wherein the multilayer film comprises additional layers selected from the group consisting of
a backing layer composed of a polyalkyl (meth)acrylate moulding composition, on the substrate side,
a colour layer,
an additional polyamide layer,
a protective layer or a clearcoat, and
a peelable protective film.

6. The method according to claim 1,
wherein the composite part is produced via adhesive bonding, pressing, or lamination, or via reverse coating by an injection-moulding, foaming or compression-moulding.

7. A composite part, comprising:
a multilayer film according to claim 1 and
a substrate comprised of a polyalkyl (meth)acrylate moulding composition.

8. The composite part according to claim 7,
wherein the substrate is shaped in the form of a sheet.

9. The composite part according to claim 7,
wherein the composite part is an optical component, a part of an automobile or of a commercial vehicle or is a medical item, sanitary item or hygienic article.

10. The process for production of a composite part according to claim 7,
wherein the composite part is produced from the multilayer film and from the substrate via adhesive bonding, pressing, or lamination, or via reverse coating by an injection-moulding, foaming, or compression-moulding.
